(19) United States
(12) Patent Application Publication
(10) Pub. No.: US 2016/0096047 A1
(43) Pub. Date: Apr. 7, 2016

(54) FALL ARREST DEVICE

(71) Applicant: Glenn Sailer, Escondido, CA (US)

(72) Inventor: Glenn Sailer, Escondido, CA (US)

(21) Appl. No.: 14/811,742

(22) Filed: Jul. 28, 2015

Related U.S. Application Data
(60) Provisional application No. 62/059,150, filed on Oct. 2, 2014.

(51) Int. Cl. A62B 35/00; F16B 37/00

(52) U.S. Cl. CPC A62B 35/0068; F16B 37/00

(57) ABSTRACT

A fall arrest device configured for attachment to a step bolt is provided for use in climbing a utility structure. The fall arrest device includes: a tube member having a shape of generally a hollow cylinder having an internal surface defining a bore therethrough, wherein one end portion of the internal surface is threaded to provide an internal thread section; and a loop member having a shape of generally an open loop, each of two end portions of which is integrally attached to an outer surface of the tube member, providing an opening defined by the loop member and the tube member between the two end portions of the loop member.

### CROSS REFERENCE

This U.S. patent application claims the benefit of U.S. provisional patent application Ser. No. 62/059,150, filed on Oct. 2, 2014.

### BACKGROUND

The present invention broadly relates to safety equipment for climbing utility structures, such as utility towers and utility poles.

Fall arrest is one form of fall protection, regulations of which are specified by OSHA to prevent individuals working at height from fall injury. Personal fall arrest is one type of fall arrest, and a personal fall arrest system typically includes at least the following four key elements: anchorage, body wear, connector, and deceleration device. An anchorage is a secure point, often referred to as a tie-off point, for attachment to a structural part such as a rebar, I-beam, scaffolding and the like. A body wear is typically a body harness worn by the worker. A deceleration device has a mechanism to dissipate a substantial amount of energy and force associated with a fall arrest event. Examples of deceleration device include a rope grab, shock-absorbing lanyard, fall limiter, self-retracting lifeline and the like, one end of which can be coupled to a body wear. A connector is a device used to couple the other end of the deceleration device to the anchorage, such as a cross-arm strap, beam anchor, snap-hook, carabiner and the like. Each of these parts of a personal fall arrest system is typically required to sustain a minimum of 5,000 pounds per worker.

A utility tower is typically constructed to have threaded holes, which are to be engaged with threaded step rungs. Such a step rung is typically formed to have a shape of a bolt, i.e., an elongated solid cylinder with a threaded end portion, which is fastened with a nut to secure the engagement with the threaded hole. A utility pole is typically constructed to have holes where step rungs are to be inserted. The end portion of such a step rung may include a hook or be properly shaped for securing the step rung through the hole.

Utility workers climb utility structures, such as utility towers and utility poles, for repair, construction, maintenance and other purposes, with a variety of safety equipment. Conventional techniques addressing fall arrest in climbing a utility tower or pole include use of fan independent component, such as a carabiner, climbing clip, hook and the like, to couple the deceleration device to the step rung installed with the structure. Other examples include a step rung integrated with an attachment to allow the climber to hook in a hook or clip installed at the end of the deceleration device, or to weave a climbing cable or rope around the step rung. However, these conventional techniques often fail to meet the requirement of supporting a load of 5,000 pounds or greater per worker. Therefore, there is a need for an easily installable step rung with reliable fall arrest capability. Furthermore, while new constructions of utility structures can be configured with safety equipment installed at the onset of construction, it is often necessary to retrofit old utility structures with new safety equipment to meet increasingly stringent safety requirements.

### BRIEF DESCRIPTION OF THE DRAWINGS

FIG. 1 illustrates a perspective view of a fall arrest device according to an embodiment when it is attached to a conventional step rod, which forms no part of the present invention.

FIG. 2 illustrates a perspective view of the fall arrest device.

FIGS. 3-5 illustrate a side view, a top view and a front view, respectively, of the fall arrest device, wherein the step rod is illustrated with dashed lines as the environment

### DETAILED DESCRIPTION

In view of the increasingly stringent safety requirements and the needs for low-cost, easy-to-implement safety equipment, this document describes a fall arrest device configured for attachment to a conventional step rod for climbing a utility structure, such as a utility tower or a utility pole, whereby existing utility structures and equipment can be retrofitted with new safety features.

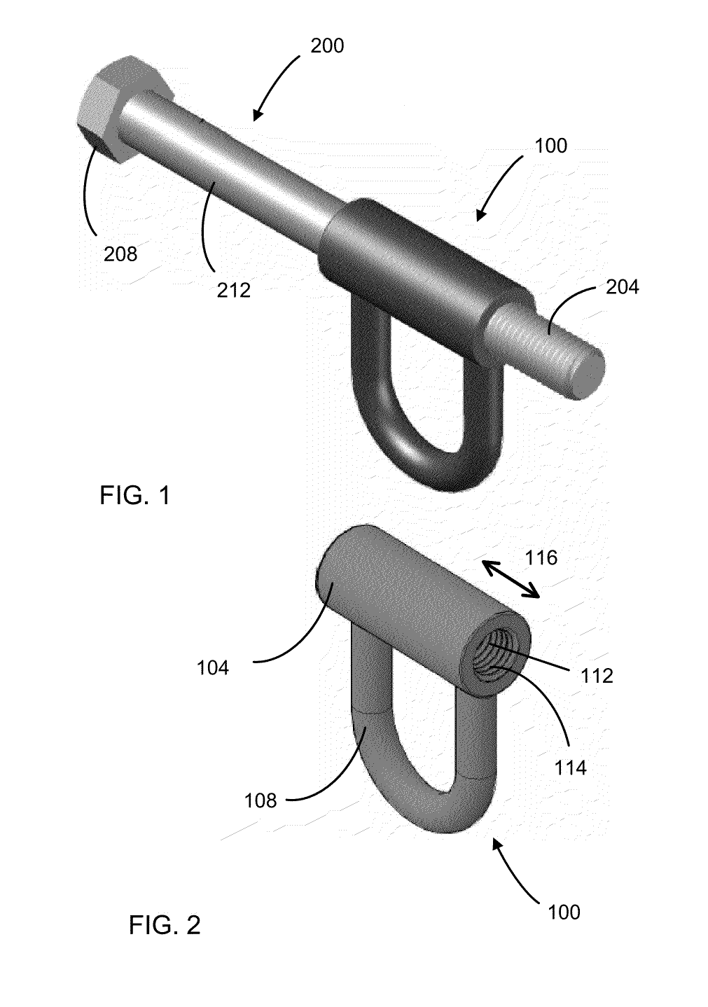

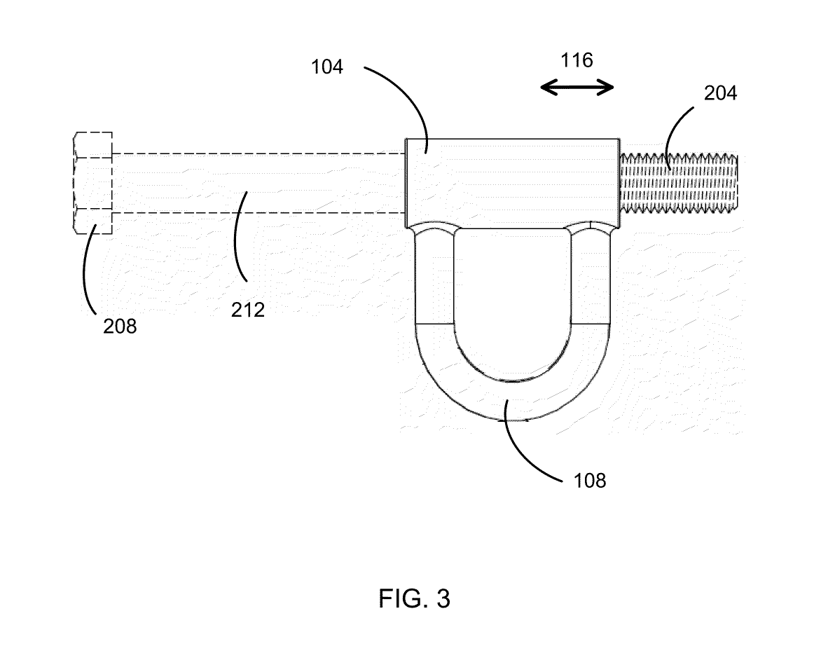

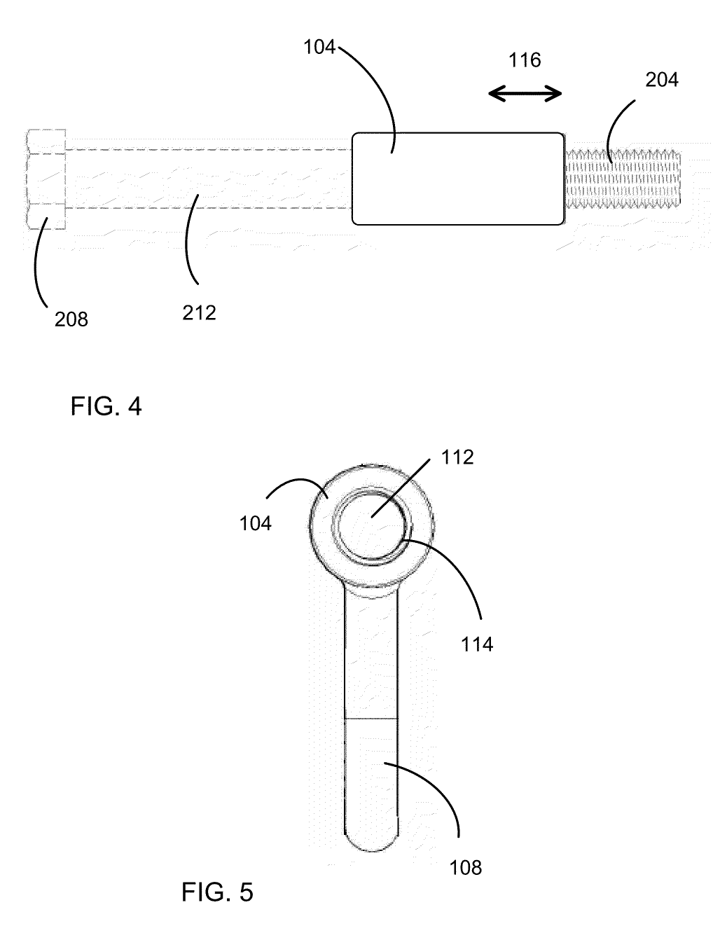

FIG. 1 illustrates a perspective view of the fall arrest device 100 according to an embodiment when it is attached to a conventional step rod 200, which forms no part of the present invention. FIG. 2 illustrates a perspective view of the present fall arrest device 100 alone. FIGS. 3-5 illustrate a side view, a top view and a front view, respectively, of the present fall arrest device 100, wherein the conventional step rod 200 is illustrated with dashed lines as the environment. The conventional step rod 200 has a shape of generally a solid cylinder, which has a thread section 204 at one end portion, a head section 208 at the other end portion and a shank section 212 therebetween. The thread section 204 generally has a length sufficient to penetrate through a hole formed in a utility structure (not shown), so that the step bolt 200 can be secured through the hole of the utility structure, with the end portion of the thread section 204 protruding from the hole to the opposite side of the utility structure. A fastener such as a nut is used to fasten the end portion of the thread section 204 to the opposite side of the utility structure. A wrench, a hand, a motor or other suitable means can be applied to the head section 208 to drive the screwing-in motion of the step bolt 200 to penetrate through the hole of the utility structure.

The present fan arrest device 100 includes a tube member 104 and a loop member 108. The tube member 104 has a shape of generally a hollow cylinder, having an internal surface defining a bore 112 therethrough. The loop member 108 has a shape of generally an open loop, each of two end portions of which is integrally attached to the outer surface of the tube member 104, providing an opening defined by the loop member 108 and the tube member 104 between the two end portions of the loop member 108. Thus, the overall shape of the fall arrest device 100 resembles a letter D in the present example.

The internal surface defining the bore 112 of the tube member 104 is threaded at one end portion, providing an internal thread section 114. The pitch of the internal thread section 114 is configured to correspond to the pitch of the thread section 204 of the conventional step rod 200. Furthermore, the longitudinal length of the internal thread section 114, indicated by a length 116 in the figures, is configured to be shorter than the longitudinal length of the thread section 204 of the conventional step rod 200, so that the internal thread section 114 can be entirely engaged with a part of the thread section 204 when the conventional step rod 200 is inserted through the bore 112. As such, the tube member 104 is configured to cylindrically envelop the part of the thread section 204 and a part of the shank section 212, which is contiguous to the thread section 204.

During actual utilization, the present fall arrest device 100 is attached to the conventional step rod 200 to form an assembly, and the assembly is installed with a utility structure. At least part of the end portion of the thread section 204 protruding from the tube member 104 is used for engagement with a hole formed in the utility structure for securing the assembly to the utility structure. When installed, the loop member 108 can be positioned to point toward the direction substantially opposite to the ascending direction, and the exposed part of the shank section 212 of the conventional step bolt 200 is used for a utility worker to step on for climbing. As mentioned earlier, a deceleration device has a mechanism to dissipate a substantial amount of energy and force associated with a fall arrest event. Examples of deceleration device include a rope grab, shock-absorbing lanyard, fall limiter, self-retracting lifeline and the like, one end of which can be coupled to a body harness the worker is wearing. The other end of the deceleration device may include a connector, such as a cross-arm strap, beam anchor, snap-hook, carabiner and the like, which can be used for engagement with the loop member 108 of the fall arrest device 100. Therefore, the loop member 108 of the fall arrest device 100 is configured for use as an anchorage of a fall arrest system, by positioning it to point toward the direction substantially opposite to the ascending direction, when the assembly of the fall arrest device 100 and the step bolt 200 is installed with the utility structure. The load testing is typically conducted to ensure the sustainability of a minimum of 5,000 pounds.

As illustrated, in FIGS. 1, 3 and 4, the fall arrest device 100 is configured for attachment around a part of the thread section 204 and apart of the shank section 212, which is contiguous to the thread section 204. That is, the fall arrest device 100 is configured for attachment at the root portion of the step bolt 200 when installed with the utility structure. The fall arrest device 100 is provided at the root portion because the torque exerted by the load to the step bolt 200 is smaller when the fall arrest device 100 is at the root portion than when it is at the other end portion close to the head section 208, thereby providing better durability and strength.

The fall arrest device 100 may be made of cast alloy steel, for example. The tube member 104 and the loop member 108 may be integrally formed by welding, molding, or other suitable processing technique.

While this document contains many specifics, these should not be construed as limitations on the scope of an invention or of what may be claimed, but rather as descriptions of features specific to particular embodiments of the invention. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in sonic cases be exercised from the combination, and the claimed combination may be directed to a subcombination or a variation of a subcombination.

What is claimed is:

1. A fall arrest device configured for attachment to a step bolt for use in climbing a utility structure, wherein the step bolt comprises a thread section at one end portion, a head section at the other end portion and a shank section therebetween, the fail arrest device comprising:
a tube member having a shape of generally a hollow cylinder having an internal surface defining a bore therethrough, wherein one end portion of the internal surface is threaded to provide an internal thread section; and
a loop member having a shape of generally an open loop, each of two end portions of which is integrally attached to an outer surface of the tube member, providing an opening defined by the loop member and the tube member between the two end portions of the loop member.

2. The fall arrest device of claim 1, wherein
a pitch of the internal thread section is configured to correspond to a pitch of the thread section of the step rod, and
a length of the internal thread section is configured to be shorter than a length of the thread section of the step rod, allowing for the internal thread section to be entirely engaged with a part of the thread section of the step rod.

3. The fall arrest device of claim 1, wherein
the tube member is configured to cylindrically envelop a part of the thread section and a part of the shank section, which is contiguous to the thread section, when the step bolt is inserted through the bore.

4. The fall arrest device of claim 1, wherein
the loop member is configured for use as an anchorage of a fall arrest system by positioning it to point toward a direction substantially opposite to an ascending direction in climbing.
